(19) United States
(12) Patent Application Publication
(10) Pub. No.: US 2011/0237155 A1
(43) Pub. Date: Sep. 29, 2011

(54) Toy House with Cube Joint

(75) Inventor: Kin LEUNG, Hong Kong (HK)

(73) Assignee: World Sun Development Limited, Hong Kong (HK)

(21) Appl. No.: 12/730,274

(22) Filed: Mar. 24, 2010

(51) Int. Cl. A63H 33/04; F16B 33/00

(52) U.S. Cl. 446/476; 411/366.1

(57) ABSTRACT

The present invention provides a toy house with cube joint which comprises a roof and a house body, of which the house body is formed by a number of roots, wherein there are some holes for the purpose of forming the roof and house body, of which the holes can connect with the holes of other roots perpendicularly by putting a wood screw into the corresponding holes on two roots. There are connecting holes spreading systematically on each root. A root can be connected with adjacent root or additional facilities by putting a cross nut into the connecting holes with the corresponding holes of adjacent root or additional facilities, and then insert two special fasteners to the corresponding perpendicular holes, the cross nut and the special fasteners (specially designed connectors) will integrate together and the roots and facilities can be connected accordingly. The present invention provides a toy house with cube joint as an enhancement. It is easily assembled and disassembled, and can easily install other facilities at its own preferences. The walls are made of transparent materials which can be easily re-decorated with different wall papers, inter alia, color transparent films, brick patterns, wood tiles, stone patterns etc by inserting into the angle slot in the root, and pictures or images can be posted on the inner/outer surface of the walls to increase the artistic appearance or change the theme of the product. The present invention is suitable for brain development of children and increases the fun of DIY.

### FIELD OF TECHNOLOGY

The present invention relates to a toy house, specifically refers to a toy house which comprises of cubes with formulated hole distances on the roots to enable the cubes to be assembled in all perpendicular and/or parallel directions and disassembled easily and made to its own preferences by customized cube joint with cross nut and special fastener.

### BACKGROUND OF THE TECHNOLOGY

At present, there are many toy houses which are designed for developing of children's fun. They are divided into two categories. One is assembled inside factory, of which it must be assembled or disassembled with specific tools. The disadvantages are time consuming and laborious. The other category is packed as a model, hence installation by parents/children itself is needed. It usually includes a roof and a house body, of which the house body includes a number of walls, wherein the edges of the walls have connected films or scarf gap for connection with others. Both categories cannot install other facilities than the prepared ones, i.e. cannot make to its own preferences and can only fix as is. Therefore, there is only one way for each model or factory pre-build toy house.

### SUMMARY OF THE UTILITY MODEL

In order to solve the aforesaid problem, the present invention proposed a toy house with cube joint as an enhancement. It is easily assembled and disassembled, and can easily install any other facilities as per own preferences. It is suitable for brain development of children and increases the fun of DIY (Do It Yourself).

A toy house with cube joint according to the present invention comprises a roof and a house body, of which the house body is formed by a number of roots, wherein there are some holes for the purpose of forming the roof and house body, of which the holes can connect with the holes of other roots perpendicularly by putting a wood screw into the corresponding holes on two roots. There are connecting holes spreading systematically on each root. A root can be connected with adjacent root or additional facilities by putting a cross nut into the connecting holes with the corresponding holes of adjacent root or additional facilities, and then insert two special fasteners to the corresponding perpendicular holes, the cross nut and the special fasteners (specially designed connector) will integrate together and the roots can be connected accordingly.

A toy house with cube joint as described, of which the house body is cubic or cuboid, wherein the inner of each root of the cubic or cuboid has two angle slots.

A toy house with cube joint as described, of which the roof and house body includes walls, wherein the walls are mounted into the angle slot of the root.

A toy house with cube joint as described, of which the walls are made of transparent materials which can be easily re-decorated with different wall papers of different styles, inter alia, color transparent films, brick patterns, wood tiles, stone patterns etc by inserting into the angles slot in the root, and pictures or images can be posted on the inner/outer surface of the walls.

A toy house with cube joint as described, of which the cross nut is cylindrical, wherein there are two vertical screw holes with their axes placed, of which the screw hole has inner thread.

A toy house with cube joint as described, of which the special fastener is formed by a screw cylinder and a screw stud, wherein the screw cylinder has outer thread, wherein the screw hole has inner thread.

A toy house with cube joint as described, of which the specially designed connector is formed by a cross nut and two special fasteners, wherein the cross nut and special fasteners can be integrated together in order to connect two cubes and other facilities in parallel.

A toy house with cube joint as described, of which the wood screw is formed by a screw cylinder and a screw stud, of which they are fixed and non detachable.

A toy house with cube joint as described, of which the spacing ratio for the connection of each holes are in specifically made and calculated, so that it can be assembled as its own preferences in every perpendicular and/or parallel direction without any difficulties.

A toy house with cube joint as described, of which it can be installed any additional facilities or accessories and can be linked, connected and stackable as its own preferences, because it is not limited to the output of the factory and the cube joint can connect to each other easily.

The present invention is characterized in that it comprises a roof and a house body, of which the house body is formed by a number of roots, wherein there are some holes for the purpose of forming the roof and house body, of which the holes can connect with the holes of other roots perpendicularly by putting a wood screw into the corresponding holes on two roots. There are connecting holes spreading systematically on each root. A root can be connected with adjacent root or additional facilities by putting a cross nut into the connecting holes with the corresponding holes of adjacent root or additional facilities, and then insert two special fasteners to the corresponding perpendicular holes, the cross nut and the special fasteners (specially designed connector) will integrate together and the roots can be connected accordingly. The present invention provides a toy house with cube joint as an enhancement. It is easily assembled and disassembled, and can easily install other facilities at its own preferences. The walls are made of transparent materials which can be easily re-decorated with different wall papers of different styles, inter alia, color transparent films, brick patterns, wood tiles, stone patterns etc by inserting into the angle slot in the root, and pictures or images can be posted on the inner/outer surface of the walls to increase the artistic appearance or change the theme of the product. The present invention is suitable for brain development of children and increases the fun of DIY.

### EXPLANATION FOR ATTACHED DRAWING

FIG. 1 is the structural drawing of a house body.

FIG. 2 is the perspective view of the house body.

FIG. 3 is the rear view of the house body.

FIG. 4 is the top view of the house body.

FIG. 5 is the front view of the special fastener.

FIG. 6 is the top view of the special fastener.

FIG. 7 is the front view of the cross nut.

FIG. 8 is the cross-section view of the cross nut.

FIG. 9 is the front view of the wood screw.

FIG. 10 is the connection drawings of the cross nut with the special fastener.

FIG. 11 is the enlarge drawing of FIG. 1 in partial.

FIG. 12 is the sample drawing of different wall paper inserted.

FIG. 13 is the sample drawing of different wall paper inserted.

FIG. 14 is the method of inserting the wall paper into the angle slot in the root.

### PARTICULAR IMPLEMENTATION METHOD

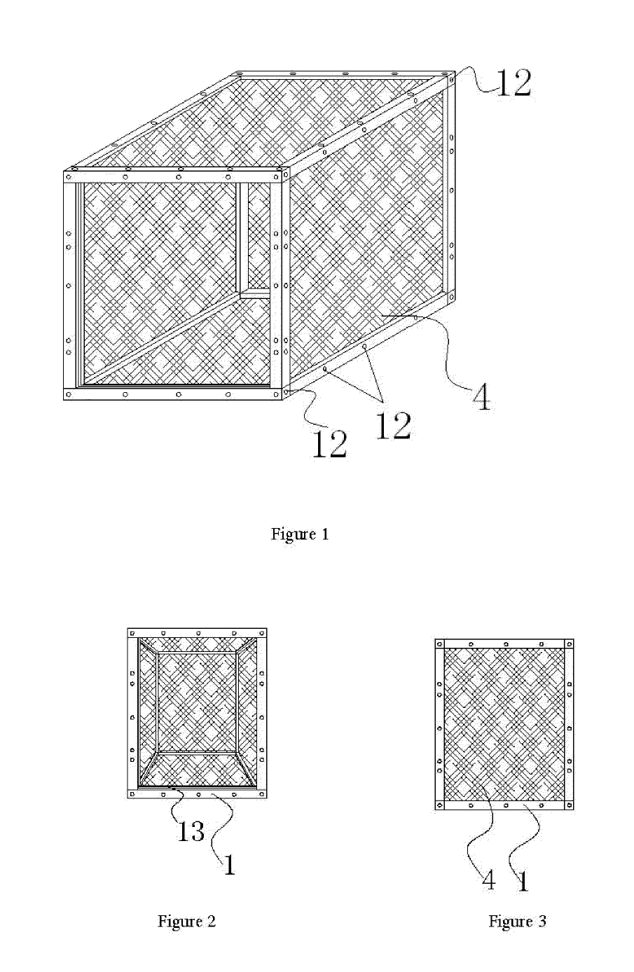

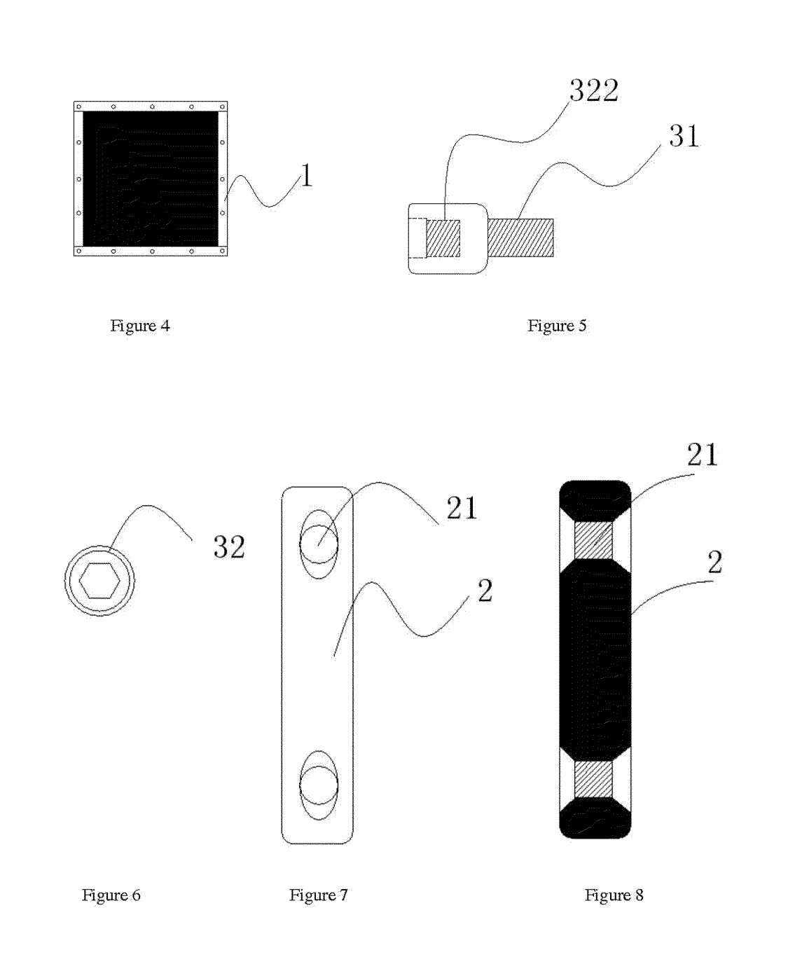

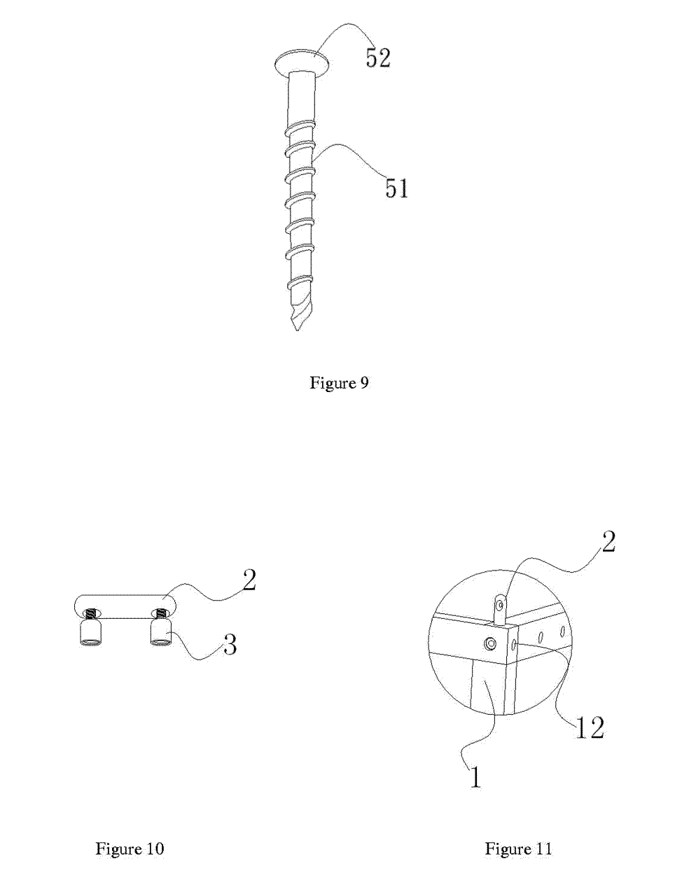

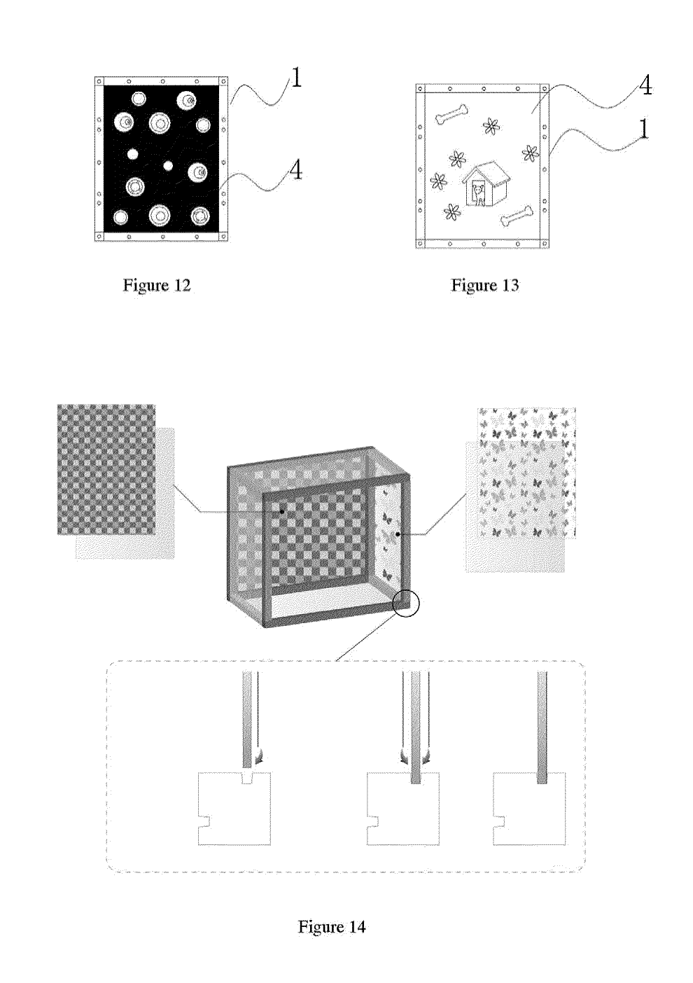

As described in FIGS. 1 to 11, a toy house with cube joint, includes a roof and a house body, of which the house body is formed by a number of roots 1, wherein there are some holes 12 for the purpose of forming the roof and house body, of which the holes 12 can connect with the holes of other roots perpendicularly by putting a wood screw into the corresponding holes 12 on two roots 1. There are connecting holes 12 spreading systematically on each root 1. A root 1 can be connected with adjacent root 1 by putting a cross nut 2 into the connecting holes 12 with the corresponding holes 12 of adjacent root 1, and then insert two special fasteners 3 to the corresponding perpendicular hole 12, the cross nut 2 and the special fasteners 3 (specially designed connector) will integrate together and the roots 1 can be connected accordingly.

The house body is cubic or cuboid, wherein the inner of each root 1 of the cubic or cuboid has two angle slots 13.

The house body as described includes walls 4, wherein the walls 4 are mounted into the angle slot 13 of the root 1.

The walls 4 are made of transparent material, wherein different wall papers of different styles, inter alia, color transparent films, brick patterns, wood tiles, stone patterns etc by inserting into the angles slot in the root, and pictures or images can be posted on the inner/outer surface of the walls 4.

The cross nut 2 is cylindrical, wherein there are two vertical screw holes 21 with their axes placed, wherein there are two vertical screw holes with their axes placed, of which the screw hole has inner thread.

The special fastener 3 is formed by a screw cylinder 31 and a screw stud 32, wherein the screw cylinder 31 has outer thread, wherein the screw hole 322 has inner thread.

The specially designed connector is formed by a cross nut 2 and two special fasteners 3, wherein the cross nut 2 and special fasteners 3 can be integrated together in order to connect two cubes and other facilities in parallel.

The wood screw is formed by a screw cylinder 51 and a screw stud 52, of which they are fixed and non detachable.

The spacing ratio for the connection of each holes are in specifically made and calculated, so that it can be assembled as its own preferences in every perpendicular and/or parallel direction without any difficulties.

A toy house with cube joint can be installed any additional facilities or accessories and can be linked, connected and stackable as its own preferences, because it is not limited to the output of the factory and the cube joint can connect to each other easily.

As described as above, the present invention is characterized in that the house body is formed by a number of roots 1, wherein there are some holes 12 for the purpose of forming the roof and house body, of which the holes 12 can connect with the holes of other roots perpendicularly by putting a wood screw into the corresponding holes 12 on two roots 1. There are connecting holes 12 spreading systematically on each root 1. A root 1 can be connected with adjacent root 1 by putting a cross nut 2 into the connecting holes 12 with the corresponding holes 12 of adjacent root 1, and then insert two special fasteners 3 to the corresponding perpendicular hole 12, the cross nut 2 and the special fasteners 3 (specially designed connector) will integrate together and the roots 1 can be connected accordingly. In comparison with the conventional technology, the present invention provides a toy house with cube joint as an enhancement. It is easily assembled and disassembled, and can easily install other facilities at its own preferences. The walls are made of transparent materials which can be easily re-decorated with different wall papers of different styles, inter alia, color transparent films, brick patterns, wood tiles, stone patterns etc by inserting into the angle slot in the root, and pictures or images can be posted on the inner/outer surface of the walls to increase the artistic appearance or change the theme of the product. The present invention is suitable for brain development of children and increases the fun of DIY.

The toy house with cube joint provided by the embodiment of the present invention is described in detail hereinbefore. As for the technical personnel generally skilled in the art, the embodiment and application scope may be changed to some extent according to the concept of the embodiment of the present invention. Therefore, the content of the specification does not set a limit on the present invention.

1. A toy house with cube joint which comprises a roof and a house body, of which the house body is formed by a number of roots, wherein there are some holes for the purpose of forming the roof and house body, of which the holes can connect with the holes of other roots perpendicularly by putting a wood screw into the corresponding holes on two roots. There are connecting holes spreading systematically on each root. A root can be connected with adjacent root or additional facilities by putting a cross nut into the connecting holes with the corresponding holes of adjacent root or additional facilities, and then insert two special fasteners to the corresponding perpendicular holes, the cross nut and the special fasteners (specially designed connector) will integrate together and the roots can be connected accordingly.

2. A toy house with cube joint of claim 1, characterized in that the house body is cubic or cuboid, wherein the inner of each root of the cubic or cuboid has two angle slots.

3. A toy house with cube joint of claim 1 or 2, characterized in that the roof and house body includes walls, wherein the walls are mounted into the angle slot of the root.

4. A toy house with cube joint of claim 3, characterized in that the walls are made of transparent materials which can be easily re-decorated with different wall papers of different styles, inter alia, color transparent films, brick patterns, wood tiles, stone patterns etc by inserting into the angles slot in the root, and pictures or images can be posted on the inner/outer surface of the walls.

5. A toy house with cube joint of claim 1, characterized in that the cross nut is cylindrical, wherein there are two vertical screw holes with their axes placed, of which the screw hole has inner thread.

6. A toy house with cube joint of claim 1, characterized in that the special fastener is formed by a screw cylinder and a screw stud, wherein the screw cylinder has outer thread, wherein the screw hole has inner thread.

7. A toy house with cube joint of claim 1, characterized in that the specially designed connector is formed by a cross nut and two special fasteners, wherein the cross nut and special fasteners can be integrated together in order to connect two cubes and other facilities in parallel.

8. A toy house with cube joint of claim 1, characterized in that the wood screw is formed by a screw cylinder and a screw stud, of which they are fixed and non detachable.

9. A toy house with cube joint of claim 1, characterized, that the spacing ratio for the connection of each holes are in specifically made and calculated, so that it can be assembled as its own preferences in every perpendicular and/or parallel direction without any difficulties.

10. A toy house with cube joint of claim 1, characterized in that it can be installed any additional facilities or accessories and can be linked, connected and stackable as its own preferences, because it is not limited to the output of the factory and the cube joint can connect to each other easily.
